(19) United States
(12) Patent Application Publication
(10) Pub. No.: US 2015/0038164 A1
(43) Pub. Date: Feb. 5, 2015

(54) SYSTEM FOR ANALYZING MOBILE TELEPHONE USERS LOCATIONS AND CLASSIFICATIONS, WHILE MAINTAINING USERS PRIVACY CONSTRAINTS

(71) Applicant: DEUTSCHE TELEKOM AG, Bonn (DE)

(72) Inventors: Yuval ELOVICI, Aruguot (IL); Dudu MIMRAN, Tel Aviv (IL); Barak CHIZI, Ashkelon (IL); Pavel ACKERMAN, Cumming, GA (US); Moshe BIXENSPANER, Ra'anana (IL)

(73) Assignee: DEUTSCHE TELEKOM AG

(21) Appl. No.: 14/337,278

(22) Filed: Jul. 22, 2014

(30) Foreign Application Priority Data
Aug. 1, 2013 (IL) 227775

(51) Int. Cl. G06F 17/30; H04W 4/02

(52) U.S. Cl. CPC G06F 17/30867; H04W 4/02
USPC 455/456.1

(57) ABSTRACT

A system provides a database ready for querying and analyzing locations of mobile phone users. The database is secured from possibility of breaching a privacy of a single user, has: (a) a signal tracker; (b) an aggregator-classifier and a step aggregator; (c) a timer; (d) a sector gate keeper and a step gate keeper for inspecting each aggregated registration record and each aggregated step record, and for forwarding to a sector gate keeper and to a step gate keeper respectively only those aggregated registration records and aggregated step records that evolve from at least a predefined number N of different users; (e) a sector writer and a step writer for receiving aggregated registration records, and aggregated step records, each evolving from at least a predefined number N of different users, and for writing all said records within a database.

### FIELD OF INVENTION

The present invention relates in general to systems for analyzing locations and classifications of mobile telephone users. More specifically, the invention relates to a system which performs such analysis without breaching the privacy of individual users.

### BACKGROUND OF THE INVENTION

It is well known that knowledge with respect to the location of mobile telephone users at specific times is valuable, at least in terms of commercial use. For example, if an owner of a specific store becomes aware that a group of users in the average age of 50-60 pass next to his store during a specific period, he will be able to offer specific type of goods during these respective periods. Similarly, if a restaurant owner becomes aware that during a specific period mostly youngsters, or alternatively people earning above the average salary pass nearby, he will be able to design the restaurant food accordingly during the respective period. There are many other advantages for such knowledge of location and classification of the telephone users (by age, average of salary, gender, etc.). Typically, mobile telephone companies are capable of obtaining relatively easily this valuable knowledge based on their communication facilities and their internal CRM databases, however, a commercial use of such knowledge may significantly breach the users' privacy. Therefore, and in order to keep the privacy of telephone users, very significant regulations are applied in most countries that strictly prohibit any use by mobile telephone companies of users' location, unless a court permission is obtained in advance, and such permissions are granted very rarely.

It is therefore an object of the present invention to provide a system and method for correlating between telephone users' classifications and their respective locations, while not causing any breach to the users' privacy.

It is another object of the present invention to provide a system which correlates location and classification of telephone users, while meeting all the existing privacy regulations.

Other objects and advantages of the present invention will become apparent as the description proceeds.

### SUMMARY OF THE INVENTION

The invention relates to a system for providing a database ready for querying and analyzing locations of mobile phone users, said database being secured from possibility of breaching a privacy of a single user, which comprises: (a) a signal tracker for receiving a flow of real-time network registrations of plurality of mobile phones, for comparing each registration with a corresponding previous registration for a same mobile phone, and for forwarding any present registration and the result of said comparison to an aggregator-classifier and a step aggregator respectively; (b) an aggregator-classifier and a step aggregator for receiving each of said registration and comparison results respectively, for consulting with a CRM with respect to each registration, and based on said consultation aggregating registration records and step records according to their classifications; (c) a timer for periodically, every period T, forwarding the aggregated registration records and the aggregated step records, as aggregated within said aggregator-classifier and within said step aggregator respectively to a sector gate keeper and to a step gate keeper respectively; (d) a sector gate keeper and a step gate keeper for inspecting each aggregated registration record and each aggregated step record, and for forwarding to a sector gate keeper and to a step gate keeper respectively only those aggregated registration records and aggregated step records that evolve from at least a predefined number N of different users; (e) a sector writer and a step writer for receiving aggregated registration records, and aggregated step records, each evolving from at least a predefined number N of different users, and for writing all said records within a database.

Preferably, all those aggregated step and registration records that are found by said gate keepers to evolve from less than N different users, are merged with proximate records within the aggregator-classifier and within the step aggregator respectively to form enlarged respective records that each evolve from more than N users, all those that enlarged records that are found by said gate keepers to evolve from more than N users are also forwarded as such to the sector gate keeper and to the step gate keeper respectively.

Preferably, the system further comprises an analyzer, for querying and performing statistical analysis within said database.

Preferably, said analyzer comprises: (a) a sector extractor and a step extractor for receiving and conveying a query to the database; (b) a coverage extractor for receiving a result of said query, and for limiting a coverage range of the result to a specific range; and (c) a shape extractor for forming a final result of the query.

### BRIEF DESCRIPTION OF THE DRAWINGS

In the drawings:

FIG. 1 describes a structure of a location and classification system with privacy constraints, according to an embodiment of the present invention; and

FIG. 2 illustrates a structure of an analyzer, according to an embodiment of the invention.

### DETAILED DESCRIPTION OF PREFERRED EMBODIMENTS

Typically, each mobile telephone operator initiates a registration procedure of each telephone device in the network once every some maximal time period T (this period typically has to meet local regulations), unless the user of the telephone has performed an action with his telephone during this period. Such user action may be, for example, conducting of a phone call, an access to the Internet via the cellular data channel, etc.). For example, according to the regulations in Germany, the maximal time period T between two operator-initiated phone registrations (of each individual telephone device), is 4 hours. This maximal period T is not the same in all countries. For example, in Poland said maximal period T is 3 hours. The phone device registration in fact records the antenna number to which the telephone is presently connected, or alternatively a cell number. Therefore, each telephone registration in fact allows the telephone company to determine, at least to some accuracy extent, the geographic location of the respective telephone device. Even though such geographic location of the device in fact enables the telephone company to also determine the respective individual user of the device (by correlating the device ID with a CRM database as existing at the company), such a location determination of an individual by the company is strictly prohibited by regulations. Moreover, the phone company is prohibited from making any statistical use of said location information, as in order to perform this statistical task, the phone company should handle the respective data in a resolution of an individual user. More specifically, if the number of users in a specific classification (classification relates, for example, to users above the age of 50, users earning above the average salary, women, youngsters, etc.), that at some specific period are located at a specific location (i.e., connected to a same specific antenna) occurs to be, for example, a single user, such a situation in fact exposes to the operator (i.e., company) to the exact location of the respective individual user, a situation which is against the strict regulations that are intended to protect the privacy of individual users. As a result, the telephone company in fact cannot make any use of such location capability.

The system and method of the present invention overcome this situation which prohibits a phone company from making use of users location data, just because it may handle in some situations a “group” of people belonging to same classification, that “are” located at some time within a same location, but this “group” may occur to be at some time a single user.

The present invention provides a system and method which eliminates any possibility of exposing a location of a single user. The present invention assures that before any data set is at all inspected or analyzed, a precondition assurance is made that the data set of registrations which is treated relates to at least some minimal number N of different phone devices. If said precondition is not met, neither analysis nor use of the respective records can be made.

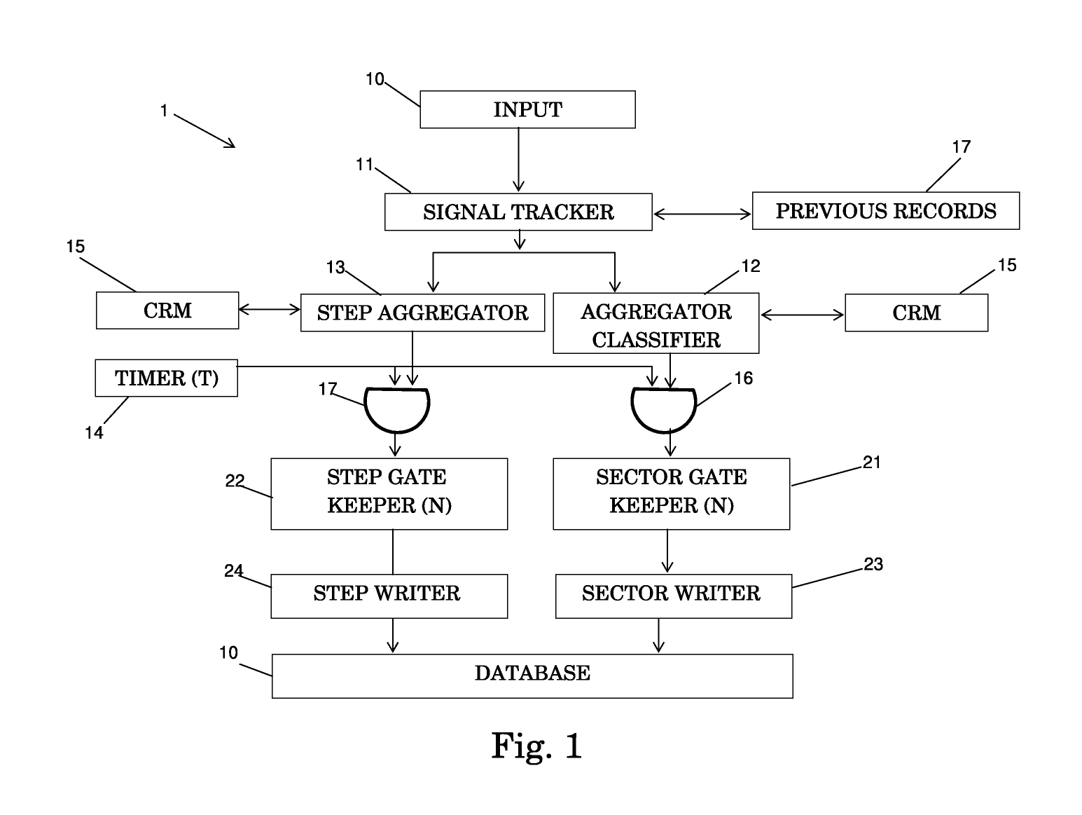

FIG. 1 describes a structure of a location and classification system 1 with privacy constraints according to an embodiment of the present invention.

A mass amount of mobile phones registration records, as received respectively from plurality of antennas (generally many antennas, typically in the order of hundreds, thousands, or even more) is received at input 10. As noted above, a phone registration record may evolve, for example, from a periodical inquiry as initiated by the cellular network against each individual mobile phone. The inquiries may be performed, for example, once every several tens of minutes or once every several hours, depending local regulations. A device registration may alternatively evolve from an action with the phone by the phone user (such as conducting of a phone call, using the device data channel, etc.). Each of such registration record comprises at least the antenna (or cell) ID, the x,y location of the user (within the antenna coverage), and the respective time of registration. All said mass flow of registrations records is initially analyzed by signal tracker 11 such that the records with respect to registrations within each sector (a “sector” relates to a specific geographic location) are maneuvered to aggregator-classifier 12. Signal tracker 11 further analyzes the input records to determine movement of a device from an area which is covered by a specific antenna (or cell) to an area covered by another antenna (or cell—hereinafter, for the sake of brevity the following description will refer to antennas only to cover both antennas records and cell records). For this purpose the signal tracker 11 consults and compares the present record with a corresponding previous record 17 for each individual device. Any time when a transfer of a device from a specific antenna to another antenna is determined, this transfer is reported to the step aggregator 13.

Aggregator-classifier 12 classifies and aggregates the various received records. The received records are aggregated based on their location, and they are also aggregated based on the individual respective user classification, as determined by consultation of the aggregator-classifier 12 with the users CRM 15, as existing at the telephone company. Such classification may divide the device users, for example, by age range, gender, salary levels, etc.

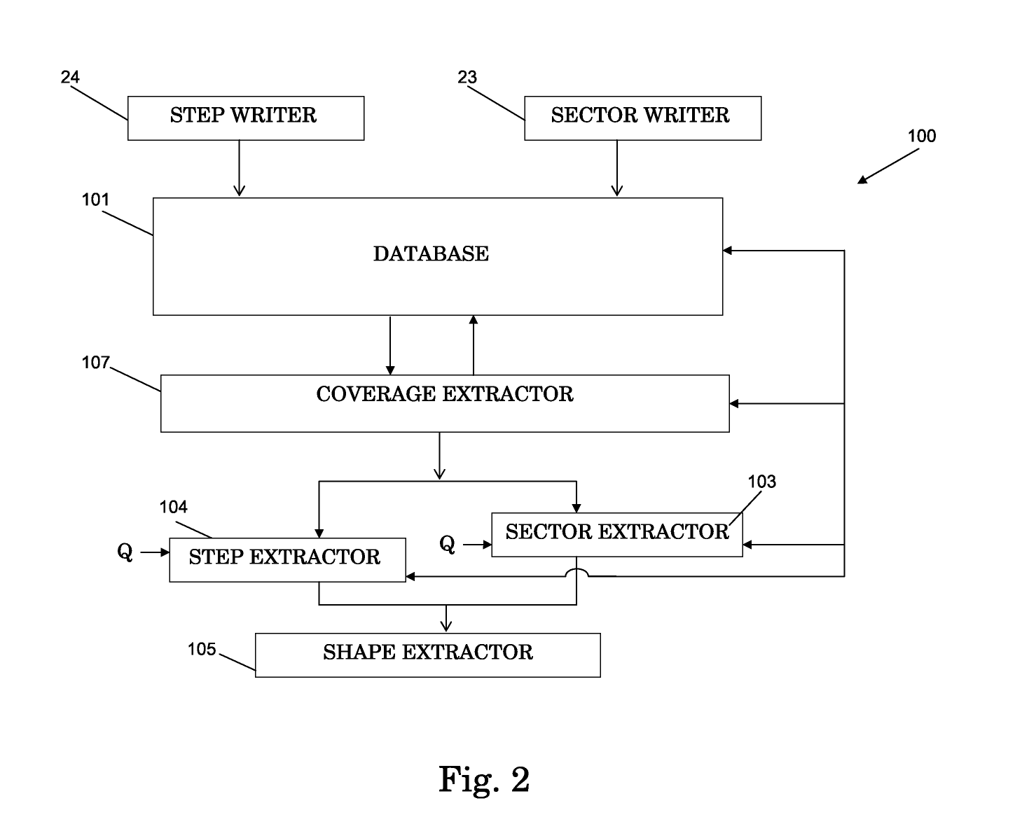

Timer 14 defines the duration T during which the aggregation is performed. The duration T may depend on specific local regulations, and may be, for example, 4 hours. Each time when the period T elapses, timer 14 opens gates 16 and 17, and the data as aggregated within aggregator-classifier 12 and step aggregator 13, respectively, is conditionally conveyed via gate-keepers 21 and 22 respectively to the sector writer 23 and to a step writer 24. More specifically, for each aggregation set which is received from the aggregator-classifier 12 and from the step aggregator 13, each of the two gate keepers 21 and 22 verifies and assures that the respective aggregation results from a number of different devices larger than N. All those aggregations resulting from less than N different devices are blocked by the gate keepers 23 and 24 respectively from entering the respective sector writer and step writer 23 and 24. In such manner, the gate keepers 21 and 22 ensure the privacy of the device users by always conveying large enough aggregation sets (i.e., each set relating to of more than N devices), while preventing forwarding of too small aggregation sets (that relate to less than N devices). Resulting from this scheme, all the aggregations within the sector writer and step writer 23 and 24 respectively cannot be used for determination or monitoring of a location of a single user and as a result, the users privacy is maintained. Sector writer 23 and step writer 24 in turn write said aggregations within a database 101 (shown in FIG. 2). The number N may be defined, for example, based on local privacy regulations. Clearly, a larger N ensures higher level of privacy than a smaller N.

In one option of the invention, when a transfer of an aggregation set is blocked by a step gate keeper 23 or by sector gate keeper 24 respectively, the data which relates to the respective sector (classification) is merged with one of the proximate aggregations to form a merged set larger than N which can be used instead without breaching the privacy regulations. For example, assuming that N=5, and an aggregation relating to a specific location and classification (for example, location L and users of 50-60 years of age) is found to include records from only two devices, this set may be merged with a proximate set of 40-50 years of age, to form a merged set of larger size which includes aggregation of users of 40-60 years of age. The larger set has a larger probability to meet the regulation requirements. In another option, the too small set of aggregation (which relates to less than N devices) is discarded.

Following each of said transfer of aggregations at the end of period T (period T may be, for example, 90 minutes), all the aggregations within the aggregator-classifier 12 and step aggregator 13 are cleared, and the aggregation process resumes from empty sets of aggregations.

Each specific aggregator summarizes those devices that have been recorded within the coverage area of a specific antenna (i.e., location Li), during the specific period Tₙ. However, typically not all of the devices that have been recorded during the period T remain within this location at the end of the period. The step aggregators that indicate those devices that left the location Lᵢ enable deduction of said devices from the relevant aggregator, and determination of those relevant devices aggregated at the end of the period.

Reference is now made to FIG. 2. As noted above, the sector writer 23 and step writer 24 write the respective “privacy approved” aggregations (i.e., those aggregations that have passed the gate keepers conditions) into database 101. FIG. 2 illustrates a structure of analyzer 100, according to an embodiment of the invention. More specifically FIG. 2 illustrates how queries are submitted into the database 101, how these queries are analyzed, and how answers to the queries are provided. A query Q is submitted to both the sector extractor 103 and step extractor 104. The query Q indicates a scope of the query, such as time duration D for which the response is requested, a classification (i.e., specific aggregation), and a geographical location (or area). The query is submitted to the database 101, and to the coverage extractor (which in turn converts the requested geographical location into antenna/s IDs). The answers to the query are received at step extractor 104 and sector extractor 103 respectively, that in turn forward the two separate answers to the shape extractor 105, which in turn constructs the final answer.

As shown, the present invention provides a system which substantially isolates the queries from any data that may infringe users' privacy. Any data which is stored within database 101, and which is accessible by queries Q is already filtered not to include such records that are in a resolution higher than predefined thresholds N and T (higher resolution means a request for information with respect to fewer users than N and/or request for information during a time period which is shorter than T). More specifically, such records that may enable querying in a higher resolution than N and or T are not at all stored within database 101, and therefore queries to obtain such higher resolution answers cannot be met. Therefore, while the system of the invention provides answers to queries with respect to location of mobile phone users during specific time periods, such answers are well protected from infringing users' privacy.

While some embodiments of the invention have been described by way of illustration, it will be apparent that the invention can be carried out with many modifications variations and adaptations, and with the use of numerous equivalents or alternative solutions that are within the scope of persons skilled in the art, without departing from the spirit of the invention or exceeding the scope of the claims.

1. A system for providing a database ready for querying and analyzing locations of mobile phone users, said database being secured from possibility of breaching a privacy of a single user, which comprises:
a. a signal tracker for receiving a flow of real-time network registrations of plurality of mobile phones, for comparing each registration with a corresponding previous registration for a same mobile phone, and for forwarding any present registration and the result of said comparison to an aggregator-classifier and a step aggregator respectively;
b. an aggregator-classifier and a step aggregator for receiving each of said registration and comparison results respectively, for consulting with a CRM with respect to each registration, and based on said consultation aggregating registration records and step records according to their classifications;
c. a timer for periodically, every period T, forwarding the aggregated registration records and the aggregated step records, as aggregated within said aggregator-classifier and within said step aggregator respectively to a sector gate keeper and to a step gate keeper respectively;
d. a sector gate keeper and a step gate keeper for inspecting each aggregated registration record and each aggregated step record, and for forwarding to a sector gate keeper and to a step gate keeper respectively only those aggregated registration records and aggregated step records that evolve from at least a predefined number N of different users;
e. a sector writer and a step writer for receiving aggregated registration records, and aggregated step records, each evolving from at least a predefined number N of different users, and for writing all said records within a database.

2. System according to claim 1, wherein all those aggregated step and registration records that are found by said gate keepers to evolve from less than N different users, are merged with proximate records within the aggregator-classifier and within the step aggregator respectively to form enlarged respective records that each evolve from more than N users, all those that enlarged records that are found by said gate keepers to evolve from more than N users are also forwarded as such to the sector gate keeper and to the step gate keeper respectively.

3. System according to claim 1, which further comprises an analyzer, for querying and performing statistical analysis within said database.

4. System according to claim 3, wherein said analyzer comprises:
a. a sector extractor and a step extractor for receiving and conveying a query to the database;
b. a coverage extractor for receiving a result of said query, and for limiting a coverage range of the result to a specific range; and
c. a shape extractor for forming a final result of the query.
